(19) United States
(12) Patent Application Publication
(10) Pub. No.: US 2019/0156098 A1
(43) Pub. Date: May 23, 2019

(54) FINGERPRINT AUTHORISABLE DEVICE

(71) Applicant: ZWIPE AS, Oslo (NO)

(72) Inventor: Marialena DEMETRIOU, Nicosia (CY)

(73) Assignee: ZWIPE AS, Oslo (NO)

(21) Appl. No.: 16/098,963

(22) PCT Filed: May 3, 2017
(86) PCT No.: PCT/EP2017/060571

§ 371 Date: Nov. 5, 2018

(30) Foreign Application Priority Data
May 4, 2016 (GB) 1607789.3

(51) Int. Cl. G06K 9/00; G06K 9/22

(52) U.S. Cl. CPC G06K 9/00013; G06K 9/00912; G06K 2009/0006; G06K 9/00087; G06K 9/228

(57) ABSTRACT

A fingerprint authorizable device includes a fingerprint sensor for obtaining fingerprint data from a user's digit, and a control system for controlling the device, where the control system is arranged to provide access to one or more functions of the device in response to identification of an authorized fingerprint, the device further including a finger placement guidance marking adjacent the fingerprint area sensor, outside of the area of the sensor surface, where the finger placement guidance marking acts to guide the location of the user's digit in the same place on the sensor each time the device is used.

### TECHNICAL FIELD

The present invention relates to a fingerprint authorizable device and to a method for controlling a fingerprint authorizable device.

### BACKGROUND

Fingerprint authorized devices such as smartcards are becoming increasingly more widely used. Smartcards for which biometric authorization has been proposed include, for example, access cards, credit cards, debit cards, pre-pay cards, loyalty cards, identity cards, cryptographic cards, and so on. Smartcards are electronic cards with the ability to store data and to interact with the user and/or with outside devices, for example via contactless technologies such as RFID. These cards can interact with sensors to communicate information in order to enable access, to authorize transactions and so on. Other devices are also known that make use of biometric authorization such as fingerprint authorization, and these include computer memory devices, building access control devices, military technologies, vehicles and so on.

Many different techniques are used to obtain an image of the finger including optical scanners, thermal scanners, capacitive scanners, E-field sensors, ultrasonic scanners, and many more. Each uses a different modality or technique to capture certain features of a person's fingerprint. Such features are commonly known as: whorls, loops, arches, and/or tented arches.

The use of biometric fingerprint sensors is a two-step process. The first step involves the user enrolling his or her fingerprint into the device. The enrolment process scans the individual's finger for the first time and stores it, along with any other pertinent information needed for future use in verification of the user's identification. The second step occurs during subsequent utilizations by the user, in which the fingerprint is authenticated. In this instance, the user's identity is now known and it is up to the system to verify the identity by comparing the newly scanned image to the data obtained and stored during enrolment. Successful authentication enables the user to proceed with whatever activity the user needed to receive identification verification.

### BRIEF SUMMARY

Viewed from a first aspect the present invention provides a fingerprint authorizable device comprising: a fingerprint area sensor for obtaining fingerprint data from a user's digit; a control system for controlling the device, wherein the control system is arranged to provide access to one or more functions of the device in response to identification of an authorized fingerprint; and one or more finger placement guidance marking(s) adjacent the fingerprint area sensor, outside of the area of the sensor surface, wherein the finger placement guidance marking(s) act to visually guide the location of the user's digit in the same place on the sensor each time the device is used.

By the use of one or more finger placement guidance marking(s) to guide the placement of the finger on the sensor this device makes it more likely that the user will reliably and repeatably place their finger in the same location on the fingerprint area sensor. This then makes the matching process more reliable and minimizes the risk of needing a second scan of the finger. It is highly likely that without guidance the user will not properly place his or her finger on the sensor during enrolment or during authentication. During enrolment, the finger should be placed consistently in the same location and in the same direction a multitude of times in order for the sensor to detect and build a “database” of the finger's features. It is very important for some types of sensors that the user covers the sensor entirely with his or her finger. Inconsistent finger placement results in a failed enrolment or failed authentication, much to the user's frustration. During subsequent uses in which the user re-scans the finger for authentication, the same misplacement of finger location and direction quite often occurs; thereby denying the user from proceeding with the intended activity requiring activation of the biometrically protected device.

It will be appreciated that a fingerprint area sensor as described herein is capable of taking a scan of any digit, including a thumb as well as a finger. It is common in this field to refer mainly to “finger” and to “fingerprint” when it is understood that a thumb/thumbprint could readily be substituted. Hence, any reference herein to a fingerprint sensor and obtaining fingerprint scans/data should be seen as also encompassing the use of a thumb in place of the finger.

If the user is taught or prompted to correctly place his or her finger (or thumb) on the sensor, then user error (and user frustration) is minimized or eliminated. Further, better positioning of the finger results in improved capturing of the targeted fingerprint area. The higher image quality achieves improvements in the algorithmic rendering of the image. The use of guidance markings as proposed herein provides an intuitive and straightforward way for the user to be taught to place their finger correctly, and the user can easily check when they have their finger in the right alignment by reference to the marking(s).

The one or more finger placement guidance marking(s) may include visible and optionally tactile elements on the surface of the device. The one or more finger placement guidance marking(s) may be located immediately adjacent the area of the fingerprint area sensor and preferably extend away from the fingerprint area sensor. Since ideally the sensor would be fully covered by the user's digit then it may be important for the marking(s) to extend some distance from the sensor, for example they may extend to a point at least 5 mm from the edge of the area sensor. The one or more finger placement guidance marking(s) may include one or more line(s), arrow(s) or dot(s). The one or more finger placement guidance marking(s) might include just a single marking at one side of the sensor. Alternatively there may be two or more markings, for example with markings at either side of the sensor.

The finger placement guide marking(s) may be one or more visible guide markings and this may exclude tactile guide markings. In this context a visible guide marking may include purely two dimensional elements, i.e. a marking on a flat surface that cannot be detected by touch, or in some cases it may include raised elements that would be tactile if they were touched, but that are not used in a tactile fashion for guiding the location of the fingertip and/or should not be in contact with the fingertip during correct use of the sensor. The visible guide markings may be arranged for alignment with a visible finger characteristic, which may be any characteristic that is visible on the user's finger and that allows the relative location of features of the fingerprint to be guided by alignment of the visible finger characteristic with the visual guide markings. Such a finger characteristic may conveniently be on the opposite side of the fingertip to the fingerprint in order that it is easily visible to the user when the fingerprint is placed on the sensor. In one example, as set out herein, this finger characteristic may be the cuticle. Thus, the finger placement guidance marking(s) may act to guide the location of the user's digit with a solely visual alignment of a visible finger characteristic with a visible guide marking. This may be done without the need for tactile guidance of the finger with the guide marking(s) and advantageously it may be done without the need for tactile engagement of the finger with the guide marking(s).

The guide marking(s) may be located beside the sensor area so as to be either side of the fingertip during use of the sensor, with the guide marking(s) establishing a visual reference line across the width of the intended placement of the fingertip for use in guiding placement of the user's digit at a required position along the length-wise direction of the digit so that the fingerprint is reliably and repeatably located on the sensor surface. The placement of the user's digit with reference to the width-wise direction of the digit may be achieved by the user placing the finger at a midpoint of the sensor area, or alternatively there may be at least two guide markings with a marking at each side of the sensor area in order that the user can locate their finger in the width-wise direction by placing it equally spaced from markings at either side of the sensor area.

It is preferred for the marking(s) to be located adjacent the sensor at a position that will align with the cuticle of a well-placed digit. The cuticle may hence provide a visible finger characteristic as in the discussion above. Thus, the marking(s) may be at one or both sides of the sensor area at about the mid-point of the sensor length. In this context the length is the dimension of the sensor in the direction along the length of the user's digit when the sensor is in use. The sensor width is then the dimension across the width of the user's finger. This length and width of the sensor may not necessarily be long and short sides respectively. By allowing for alignment of the cuticle with the one or more finger placement guidance marking(s) it is possible to provide a reliable and simple mechanism for ensuring accurate placement of the user's digit, with the location being repeated each time the sensor is used.

The control system may be arranged to indicate a failed scan during authentication or enrolment and to provide an indication if it is determined that the finger is badly placed. Thus, the fingerprint authorizable device may include an indicator, such as a light source, which illuminates to prompt the user to check the finger position and adjust it as necessary for a repeated scan of the fingerprint.

The authorized user may initially enroll their fingerprint with the device, optionally indirectly through some other device, but preferably directly onto the device via the fingerprint sensor, and may then typically be required to place their finger or thumb on the fingerprint sensor in order to authorize some or all uses of the device. A fingerprint matching algorithm in the control system may be used to identify a fingerprint match between an enrolled user and a fingerprint sensed by the fingerprint sensor.

It is preferred for the device to be arranged so that it is impossible to extract the data used for identifying users via fingerprint authorization. This data may be a fingerprint template or the like. The transmission of this type of data outside of the device is considered to be one of the biggest risks to the security of the device.

To avoid any need for communication of the fingerprint data outside of the device then the device is preferably able to self-enroll, i.e. the control system may be arranged to enroll an authorized user by obtaining fingerprint data via the fingerprint sensor. This also has advantages arising from the fact that the exact same sensor with the same geometry and the same guide markings is used for the enrolment as for the fingerprint authorization. The fingerprint data can be obtained more consistently in this way compared to the case where a different sensor on a different device is used for enrolment. With fingerprint biometrics, one problem has been that it is difficult to obtain repeatable results when the initial enrolment takes place in one place, such as a dedicated enrolment terminal, and the subsequent enrolment for matching takes place in another, such as the terminal where the matching is required. The mechanical features of the housing around each fingerprint sensor must be carefully designed to guide the finger in a consistent manner each time it is read by any one of multiple sensors. If a fingerprint is scanned with a number of different terminals, each one being slightly different, then errors can occur in the reading of the fingerprint. Conversely, if the same fingerprint sensor is used every time then the likelihood of such errors occurring is reduced. This is particular the case with the currently proposed device, where the sensor is provided along with added guide markings to enhance the reliability and repeatability of positioning of the finger on the device.

In accordance with the proposed device, both the matching and enrolment scans may be performed using the same fingerprint sensor. As a result, scanning errors can be balanced out because, for example, if a user tends to present their finger with a lateral bias during enrolment, then they are likely to do so also during matching.

The control system may have an enrolment mode in which a user may enroll their fingerprint via the fingerprint sensor, with the fingerprint data generated during enrolment being stored on the memory. The control system may be in the enrolment mode when the device is first provided to the user, so that the user can immediately enroll their fingerprint data. The first enrolled user may be provided with the ability to later prompt an enrolment mode for subsequent users to be added, for example via input on an input device of the device after identification has been confirmed. Alternatively or additionally it may be possible to prompt the enrolment mode of the control system via outside means, such as via interaction between the device and a secure system, which may be a secure system controlled by the manufacturer or by another authorized entity.

The control system may include a fingerprint processor for executing the fingerprint matching algorithm and a memory for storing fingerprint data for enrolled fingerprints. The control system of the device may include multiple processors, wherein the fingerprint processor may be a separate processor associated with the fingerprint sensor. Other processors of the control system and/or elsewhere on the device may include a control processor for controlling basic functions of the device, such as communication with other devices (e.g. via contactless technologies), activation and control of receivers/transmitters, activation and control of secure elements such as for financial transactions and so on. The various processors could be embodied in separate hardware elements, or could be combined into a single hardware element, possibly with separate software modules.

The device may be a portable device, by which is meant a device designed for being carried by a person, preferably a device small and light enough to be carried conveniently. The device can be arranged to be carried within a pocket, handbag or purse, for example. The device may be a smartcard such as a fingerprint authorizable RFID card. The device may be a control token for controlling access to a system external to the control token, such as a one-time-password device for access to a computer system or a fob for a vehicle keyless entry system. The device is preferably also portable in the sense that it does not rely on a wired power source. The device may be powered by an internal battery and/or by power harvested contactlessly from a reader or the like, for example from an RFID reader.

The device may be a single-purpose device, i.e. a device for interacting with a single external system or network or for interacting with a single type of external system or network, wherein the device does not have any other purpose. Thus, the device is to be distinguished from complex and multi-function devices such as smartphones and the like.

Where the device is a smartcard then smartcard may be any one of: an access card, a credit card, a debit card, a pre-pay card, a loyalty card, an identity card, a cryptographic card, or the like. The smartcard preferably has a width of between 85.47 mm and 85.72 mm, and a height of between 53.92 mm and 54.03 mm. The smartcard may have a thickness less than 0.84 mm, and preferably of about 0.76 mm (e.g. ±0.08 mm). More generally, the smartcard may comply with ISO 7816, which is the specification for a smartcard.

Where the device is a control token it may for example be a keyless entry key for a vehicle, in which case the external system may be the locking/access system of the vehicle and/or the ignition system. The external system may more broadly be a control system of the vehicle. The control token may act as a master key or smart key, with the radio frequency signal giving access to the vehicle features only being transmitted in response to fingerprint identification of an authorized user. Alternatively the control token may act as a remote locking type key, with the signal for unlocking the vehicle only being able to be sent if the fingerprint authorization module identifies an authorized user. In this case the identification of the authorized user may have the same effect as pressing the unlock button on prior art keyless entry type devices, and the signal for unlocking the vehicle may be sent automatically upon fingerprint identification of an authorized user, or sent in response to a button press when the control token has been activated by authentication of an authorized user.

The device may be capable of wireless communication, such as using RFID or NFC communication. Alternatively or additionally the device may comprise a contact connection, for example via a contact pad or the like such as those used for “chip and pin” payment cards. In various embodiments, the device may permit both wireless communication and contact communication.

Viewed from a second aspect, the invention provides a method for manufacturing a fingerprint authorizable device having a fingerprint area sensor for obtaining fingerprint data from a user's finger or thumb, and a control system for controlling the device; the method comprising: providing one or more finger placement guidance marking(s) on the device adjacent the fingerprint area sensor, outside of the area of the sensor surface, wherein the finger placement guidance marking(s) act to visually guide the location of the user's digit in the same place on the sensor each time the device is used.

The method may include providing further features as described above in connection with the fingerprint authorizable device. The one or more finger placement guidance marking(s) may be provided as described above, and for example may include visible and optionally tactile elements on the surface of the device. The method may include forming the one or more finger placement guidance marking(s) by printing, etching, molding and/or embossing, for example. The method may include providing a fingerprint matching algorithm in the control system to identify a fingerprint match between an enrolled user and a fingerprint sensed by the fingerprint sensor. The method may include providing the control system with an enrolment mode to enroll an authorized user by obtaining fingerprint data via the fingerprint sensor.

### BRIEF DESCRIPTION OF THE DRAWINGS

Certain preferred embodiments on the present invention will now be described in greater detail, by way of example only and with reference to the accompanying drawings, in which:

FIG. 1 shows a fingerprint authorizable device with a fingerprint area sensor and guidance markings;

FIG. 2 shows the device of FIG. 1 with a finger aligned with the guidance markings;

FIG. 3 illustrates a circuit for a smartcard with a fingerprint sensor;

FIG. 4 shows an example of a smartcard with an external housing having finger placement guidance markings; and

FIG. 5 shows an example laminated type smartcard with finger placement guidance markings.

### DETAILED DESCRIPTION

By way of example the invention is described in the context of a fingerprint authorized smartcard that includes contactless technology and uses power harvested from the card reader. These features are envisaged to be advantageous features of one application of the proposed finger placement guidance markings, but are not seen as essential features. The smartcard may hence alternatively use a physical contact and/or include a battery providing internal power, for example. The finger placement guidance markings can also be implemented with appropriate modifications in any other device or system that uses fingerprint authorization.

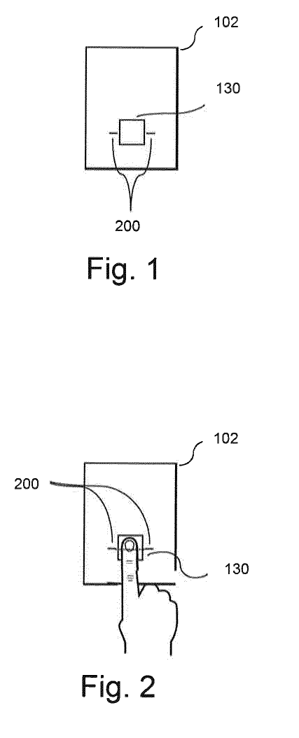

Biometric fingerprint sensors 130 are typically placed on the flat surface of a fingerprint authorizable device, which is a smartcard 102 in this example. As shown in FIGS. 1 and 2 the presence of finger placement guidance markings 200 will serve to prompt the user to align their finger (or thumb) correctly. In this example the finger placement guidance markings 200 are positioned on the left and right sides of the sensor 130 and arranged so that they should align with the finger's cuticle when the finger is correctly located, as shown in FIG. 2. Such placement of the finger placement guidance markings 200 will almost perfectly position the core minutia of a fingerprint both horizontally and vertically on the sensor 130, ultimately resulting in proper placement of the finger (or thumb) for both successful enrollment and successful authentications. The finger placement guidance markings 200 can be placed on the left and right sides of the sensor 130 by molding an embossed line on the surface of the fingerprint authorizable device 102; or the finger placement guidance markings 200 could be printed directly on a plastic, PVC, or laminate layer.

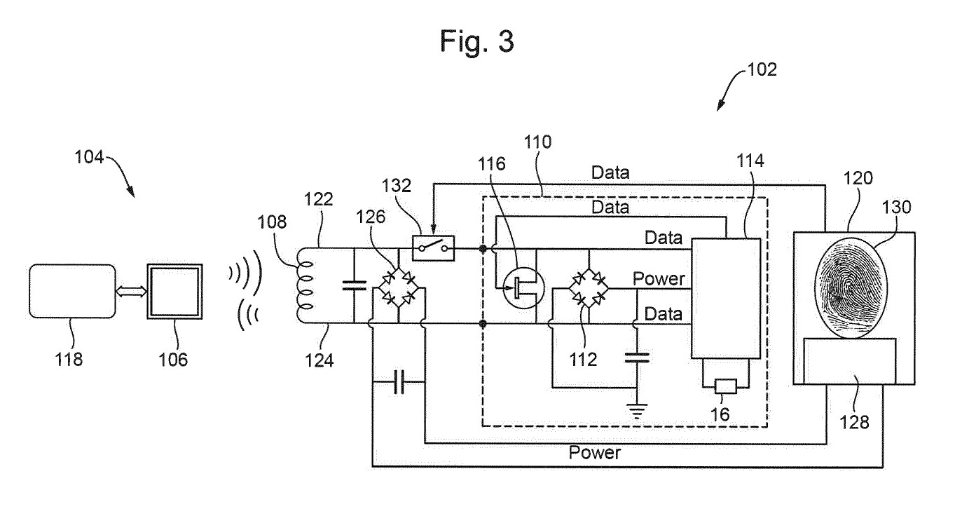

FIG. 3 shows the architecture of an example smartcard 102 that can be provided with the finger placement guidance markings 200. A powered card reader 104 transmits a signal via an antenna 106. The signal is typically 13.56 MHz for MIFARE® and DESFire® systems, manufactured by NXP Semiconductors, but may be 125 kHz for lower frequency PROX® products, manufactured by HID Global Corp. This signal is received by an antenna 108 of the smartcard 102, comprising a tuned coil and capacitor, and then passed to a communication chip 110. The received signal is rectified by a bridge rectifier 112, and the DC output of the rectifier 112 is provided to processor 114 that controls the messaging from the communication chip 110.

A control signal output from the processor 114 controls a field effect transistor 116 that is connected across the antenna 108. By switching on and off the transistor 116, a signal can be transmitted by the smartcard 102 and decoded by suitable control circuits 118 in the sensor 104. This type of signaling is known as backscatter modulation and is characterized by the fact that the sensor 104 is used to power the return message to itself.

An accelerometer 16, which is an optional feature, is connected in an appropriate way to the processor 114. The accelerometer 16 can be a Tri-axis Digital Accelerometer as provided by Kionix, Inc. of Ithaca, N.Y., USA and in this example it is the Kionix KXCJB-1041 accelerometer. The accelerometer senses movements of the card and provides an output signal to the processor 114, which is arranged to detect and identify movements that are associated with required operating modes on the card as discussed below. The accelerometer 16 may be used only when power is being harvested from the powered card reader 104, or alternatively the smartcard 102 may be additionally provided with a battery (not shown in the Figures) allowing for the accelerometer 16, and also the related functionalities of the processor 114 and other features of the device to be used at any time.

The smartcard further includes a fingerprint authentication engine 120 including a fingerprint processor 128 and the fingerprint sensor 130. This allows for enrolment and authorization via fingerprint identification. The fingerprint processor 128 and the processor 114 that controls the communication chip 110 together form a control system for the device. The two processors could in fact be implemented as software modules on the same hardware, although separate hardware could also be used. As with the accelerometer 16 (where present) the fingerprint sensor 130 may be used only when power is being harvested from the powered card reader 104, or alternatively the smartcard 102 may be additionally provided with a battery (not shown in the Figures) allowing power to be provided at any time for the fingerprint sensor 130 and fingerprint processor 128, as well as the processor 114 and other features of the device.

The antenna 108 comprises a tuned circuit including an induction coil and a capacitor, which are tuned to receive an RF signal from the card reader 104. When exposed to the excitation field generated by the sensor 104, a voltage is induced across the antenna 108.

The antenna 108 has first and second end output lines 122, 124, one at each end of the antenna 108. The output lines of the antenna 108 are connected to the fingerprint authentication engine 120 to provide power to the fingerprint authentication engine 120. In this arrangement, a rectifier 126 is provided to rectify the AC voltage received by the antenna 108. The rectified DC voltage is smoothed using a smoothing capacitor and then supplied to the fingerprint authentication engine 120.

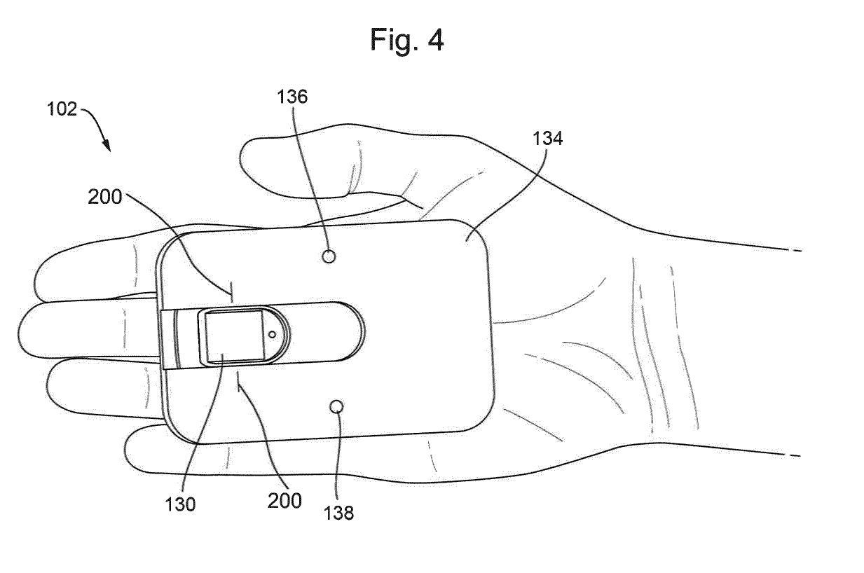

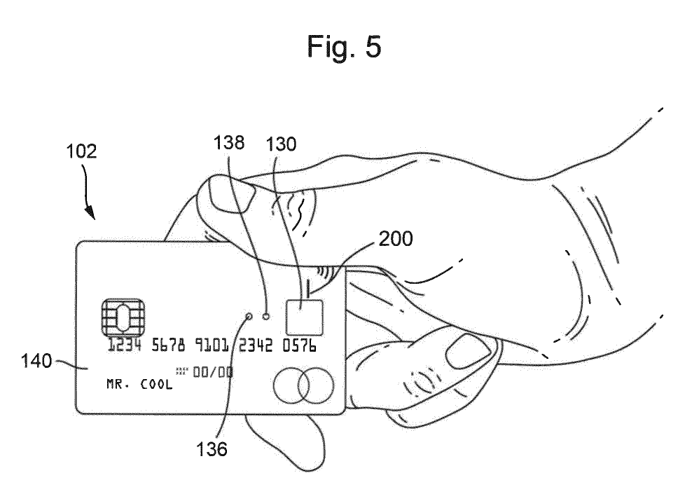

The fingerprint sensor 130 of the fingerprint authorization engine, which is an area fingerprint sensor 130, may be mounted on a card housing 134 as shown in FIG. 4 or fitted so as to be exposed from a laminated card body 140 as shown in FIG. 5. The card housing 134 or the laminated body 140 encases all of the components of FIG. 3, and is sized similarly to conventional smartcards. In each case finger placement guidance markings 200 are included either at both sides of the sensor, or on just one side of the sensor, for alignment with the cuticle as explained above. In the case of the laminated card of FIG. 5, the packaging of the card and the need for other areas of the surface of the card to be allocated to other elements means that space is limited and so just a single finger placement guidance marking 200 is used. This still provides advantages, as explained above, and allows for easier location of the sensor 130 when there are other constraints on placement of components on the surface of the card 102.

The fingerprint authentication engine 120 can be passive, and hence powered only by the voltage output from the antenna 108, although the smartcard 102 may also include a battery as mentioned above. The battery can power the fingerprint authentication engine 120 as well as other processors and user interfaces such as the graphical user interface 18, the accelerometer 16 and the LEDs 136, 138. The processor 128 comprises a microprocessor that is chosen to be of very low power and very high speed, so as to be able to perform fingerprint matching in a reasonable time.

The fingerprint authentication engine 120 is arranged to scan a finger or thumb presented to the fingerprint sensor 130 and to compare the scanned fingerprint of the finger or thumb to pre-stored fingerprint data using the processor 128. A determination is then made as to whether the scanned fingerprint matches the pre-stored fingerprint data. In a preferred embodiment, the time required for capturing a fingerprint image and authenticating the bearer of the card 102 is less than one second.

If a fingerprint match is determined and/or if appropriate movements are detected via the accelerometer 16, then the processor takes appropriate action depending on its programming. In this example the fingerprint authorization process is used to authorize the use of the smartcard 104 with the contactless card reader 104. Thus, the communication chip 110 is authorized to transmit a signal to the card reader 104 when a fingerprint match is made. The communication chip 110 transmits the signal by backscatter modulation, in the same manner as the conventional communication chip 110. The card may provide an indication of successful authorization using a suitable indicator, such as a first LED 136.

The processor 114 receives the output from the accelerometer 16, where present, and this allows the processor 114 to determine what movements of the smart card 102 have been made. The processor 114 can then identify pre-set movements and other actions of the user that can be linked with required changes to the operating mode of the smartcard.

The operating modes that the processor 114 activates or switches to in response to an identified movement associated with the required change in operating mode may include turning the card on or off, activating secure aspects of the card 102 such as contactless payment, or changing the basic functionality of the card 102 for example by switching between operating as an access card, a payment card, a transportation smartcard, switching between different accounts of the same type (e.g. two bank accounts), switching between communications protocols (such as blue tooth, wifi, NFC) and/or activating a communication protocol, activating a display such as an LCD or LED display, obtaining an output from the smartcard 102, such as a one-time-password or the like, or prompting the card 102 to automatically perform a standard operation of the smartcard 102.

The processor 114 has an enrolment mode, which may be activated upon first use of the smartcard 102. In the enrolment mode the user is prompted to enroll their fingerprint data via the fingerprint sensor 130. This can require a repeated scan of the fingerprint via the fingerprint sensor 130 so that the fingerprint processor 128 can build up appropriate fingerprint data, such as a fingerprint template. The user is instructed to align their finger (or thumb) on the sensor guided by the finger placement guidance markings 200. This ensures that the finger is correctly located during enrolment, and that this location can be reliably repeated during later authorization.

1. A fingerprint authorizable device comprising:
a fingerprint area sensor for obtaining fingerprint data from a user's digit;
a control system for controlling the device, wherein the control system is arranged to provide access to one or more functions of the device in response to identification of an authorized fingerprint; and
a finger placement guidance marking adjacent the fingerprint area sensor, outside of a surface of the fingerprint area sensor, wherein the finger placement guidance marking acts to visually guide the location of the user's digit in the same place on the sensor each time the device is used.

2. A fingerprint authorizable device as claimed in claim 1, wherein the finger placement guidance marking includes at least one of visible and tactile elements on a surface of the device.

3. A fingerprint authorizable device as claimed in claim 1, wherein the finger placement guidance marking is located immediately adjacent the fingerprint area sensor and extends away from the fingerprint area sensor.

4. A fingerprint authorizable device as claimed in claim 3, wherein the finger placement guidance marking extends to a point at least 5 mm from an edge of the fingerprint area sensor.

5. A fingerprint authorizable device as claimed in claim 1, wherein the finger placement guidance marking includes at least one of a line, an arrow or a dot.

6. A fingerprint authorizable device as claimed in claim 1, wherein the finger placement guidance marking includes a plurality of markings, with markings at either side of the fingerprint area sensor.

7. A fingerprint authorizable device as claimed in claim 1, wherein the finger placement guide marking includes a visible guide markings arranged for alignment with a visible finger characteristic in order to guide the location of the user's digit.

8. A fingerprint authorizable device as claimed in claim 1, wherein the device does not include a tactile finger placement guide marking.

9. A fingerprint authorizable device as claimed in claim 7, wherein the finger placement guide marking acts to guide the location of the user's digit with a solely visual alignment of a visible finger characteristic with the visible guide marking either without the need for tactile guide marking or without the need for tactile engagement of the finger with the guide marking.

10. A fingerprint authorizable device as claimed in claim 1, wherein the finger placement guidance marking includes a marking adjacent the fingerprint area sensor at a position that will align with a cuticle of a well-placed digit.

11. A fingerprint authorizable device as claimed in claim 10, wherein the marking for alignment with the cuticle is at a side of the fingerprint area sensor at about a mid-point of a sensor length.

12. A fingerprint authorizable device as claimed in claim 1, wherein the control system is arranged to enroll an authorized user by obtaining fingerprint data via the fingerprint area sensor.

13. A fingerprint authorizable device as claimed in claim 1, wherein the control system has an enrollment mode in which a user may enroll their fingerprint via the fingerprint sensor with the fingerprint data generated during enrolment being stored by the control system.

14. A fingerprint authorizable device as claimed in claim 1, wherein the device is a portable device.

15. A fingerprint authorizable device as claimed in claim 1, wherein the device is a smartcard.

16. A fingerprint authorizable device as claimed in claim 1, wherein the device is a fingerprint authorizable RFID card.

17. A method for manufacturing a fingerprint authorizable device having a fingerprint area sensor for obtaining fingerprint data from a user's finger or thumb, and a control system for controlling the device; the method comprising:
providing a finger placement guidance marking on the device adjacent the fingerprint area sensor, outside of an area of a sensor surface, wherein the finger placement guidance marking acts to guide a location of the user's digit in the same place on the fingerprint area sensor each time the device is used.

18. A method as claimed in claim 17, comprising providing the device with a fingerprint area sensor for obtaining fingerprint data from a user's digit, a control system for controlling the device, wherein the control system is arranged to provide access to one or more functions of the device in response to identification of an authorized fingerprint, and a finger placement guidance marking adjacent the fingerprint area sensor, outside of a surface of the fingerprint area sensor, wherein the finger placement guidance marking acts to visually guide the location of the user's digit in the same place on the sensor each time the device is used.
